(19) United States
(12) Patent Application Publication
(10) Pub. No.: US 2025/0142337 A1
(43) Pub. Date: May 1, 2025

(54) INTELLIGENT SECURITY FOR ZERO TRUST IN MOBILE NETWORKS WITH SECURITY PLATFORMS USING A PACKET FORWARDING CONTROL PROTOCOL

(71) Applicant: Palo Alto Networks, Inc., Santa Clara, CA (US)

(72) Inventors: Sachin Verma, Danville, CA (US); Leonid Burakovsky, Pleasanton, CA (US)

(21) Appl. No.: 18/525,342

(22) Filed: Nov. 30, 2023

Related U.S. Application Data
(60) Provisional application No. 63/546,724, filed on Oct. 31, 2023.

(51) Int. Cl. H04W 12/121; H04W 12/088; H04W 12/37

(52) U.S. Cl. CPC H04W 12/121; H04W 12/088; H04W 12/37

(57) ABSTRACT

Techniques for applying intelligent security for zero trust in mobile networks with perimeter security platforms using a packet forwarding control protocol (PFCP) are disclosed. In some embodiments, a system/process/computer program product for applying intelligent security for zero trust in mobile networks with perimeter security platforms (e.g., using the PFCP protocol) includes deploying a security platform in a 5G and/or 4G/LTE mobile network environment, and monitoring PFCP messages at the security platform in a standalone 5G network and/or 4G/LTE network (e.g., with a CUPS architecture). Specifically, the security platform is configured to process PFCP messages including PFCP session establishment request/response messages and/or PFCP session modification request/response messages to extract contextual information, which can include User Equipment (UE) IP, International Mobile Subscription Identity (IMSI)/Subscription Permanent Identifier (SUPI), IMEI/PEI, S-NSSAI, APN/DNN, and/or RAT Type information. The security platform is further configured to apply a security policy (e.g., enforce one or more security rules) based on the contextual information.

### CROSS REFERENCE TO OTHER APPLICATIONS

This application claims priority to U.S. Provisional Patent Application No. 63/546,724 entitled INTELLIGENT SECURITY FOR ZERO TRUST IN MOBILE NETWORKS WITH SECURITY PLATFORMS filed Oct. 31, 2023, which is incorporated herein by reference for all purposes.

### BACKGROUND OF THE INVENTION

A firewall generally protects networks from unauthorized access while permitting authorized communications to pass through the firewall. A firewall is typically a device or a set of devices, or software executed on a device, such as a computer, which provides a firewall function for network access. For example, firewalls can be integrated into operating systems of devices (e.g., computers, smart phones, or other types of network communication capable devices). Firewalls can also be integrated into or executed as software on computer servers, gateways, network/routing devices (e.g., network routers), or data appliances (e.g., security appliances or other types of special purpose devices).

Firewalls typically deny or permit network transmission based on a set of rules. These sets of rules are often referred to as policies. For example, a firewall can filter inbound traffic by applying a set of rules or policies. A firewall can also filter outbound traffic by applying a set of rules or policies. Firewalls can also be capable of performing basic routing functions.

### BRIEF DESCRIPTION OF THE DRAWINGS

Various embodiments of the invention are disclosed in the following detailed description and the accompanying drawings.

FIG. 1A is a block diagram of a first example service deployment architecture of a 5G and 4G mobile network for applying intelligent security for zero trust in mobile networks with perimeter security platforms using the PFCP protocol in accordance with some embodiments.

FIG. 1B is a block diagram of a second example service deployment architecture of a 5G mobile network service deployment architecture of a 5G and 4G mobile network for applying intelligent security for zero trust in mobile networks with perimeter security platforms using the PFCP protocol in accordance with some embodiments.

FIG. 1C is a block diagram of a third example service deployment architecture of a 4G mobile network service deployment architecture for applying intelligent security for zero trust in mobile networks with perimeter security platforms using the PFCP protocol in accordance with some embodiments.

FIG. 2A is a protocol diagram of Radius accounting message flow in a 5G network in accordance with some embodiments.

FIG. 2B is a protocol diagram of Radius accounting update message flow in a 5G network in accordance with some embodiments.

FIG. 2C is a block diagram of a first example service deployment architecture of a 5G mobile network for applying intelligent security for zero trust in mobile networks with perimeter security platforms using the Radius protocol in accordance with some embodiments.

FIG. 2D is a block diagram of a second example service deployment architecture of a 5G mobile network for applying intelligent security for zero trust in mobile networks with perimeter security platforms using the Radius protocol in accordance with some embodiments.

FIG. 2E is a protocol diagram of Radius message flow in a 4G/LTE network in accordance with some embodiments.

FIG. 2F is a protocol diagram of Radius accounting update message flow in a 4G/LTE network in accordance with some embodiments.

FIG. 2G is a block diagram of a first example service deployment architecture of a 4G mobile network for applying intelligent security for zero trust in mobile networks with perimeter security platforms using the Radius protocol in accordance with some embodiments.

FIG. 3A is a protocol diagram of Diameter accounting message flow in a 5G network in accordance with some embodiments.

FIG. 3B is a protocol diagram of Radius accounting update message flow in a 5G network in accordance with some embodiments.

FIG. 3C is a block diagram of a first example service deployment architecture of a 5G mobile network for applying intelligent security for zero trust in mobile networks with perimeter security platforms using the Diameter protocol in accordance with some embodiments.

FIG. 3D is a protocol diagram of Diameter accounting message flow on an SGi interface in a 4G/LTE network in accordance with some embodiments.

FIG. 3E is a protocol diagram of Diameter accounting update message flow in a 4G/LTE network in accordance with some embodiments.

FIG. 3F is a block diagram of a first example service deployment architecture of a 4G mobile network for applying intelligent security for zero trust in mobile networks with perimeter security platforms using the Diameter protocol in accordance with some embodiments.

FIG. 4A is a functional diagram of hardware components of a network device for applying intelligent security for zero trust in mobile networks with perimeter security platforms in accordance with some embodiments.

FIG. 4B is a functional diagram of logical components of a network device for applying intelligent security for zero trust in mobile networks with perimeter security platforms in accordance with some embodiments.

FIG. 5 is a flow diagram of a process for applying intelligent security for zero trust in mobile networks with perimeter security platforms using the PFCP protocol in accordance with some embodiments.

FIG. 6 is a flow diagram of a process for applying intelligent security for zero trust in mobile networks with perimeter security platforms using the Radius protocol in accordance with some embodiments.

FIG. 7 is a flow diagram of a process for applying intelligent security for zero trust in mobile networks with perimeter security platforms using the Diameter protocol in accordance with some embodiments.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

A firewall generally protects networks from unauthorized access while permitting authorized communications to pass through the firewall. A firewall is typically a device, a set of devices, or software executed on a device that provides a firewall function for network access. For example, a firewall can be integrated into operating systems of devices (e.g., computers, smart phones, or other types of network communication capable devices). A firewall can also be integrated into or executed as software applications on various types of devices or security devices, such as computer servers, gateways, network/routing devices (e.g., network routers), or data appliances (e.g., security appliances or other types of special purpose devices).

Firewalls typically deny or permit network transmission based on a set of rules. These sets of rules are often referred to as policies (e.g., network policies or network security policies). For example, a firewall can filter inbound traffic by applying a set of rules or policies to prevent unwanted outside traffic from reaching protected devices. A firewall can also filter outbound traffic by applying a set of rules or policies (e.g., allow, block, monitor, notify or log, and/or other actions can be specified in firewall/security rules or firewall/security policies, which can be triggered based on various criteria, such as described herein). A firewall may also apply anti-virus protection, malware detection/prevention, or intrusion protection by applying a set of rules or policies.

Security devices (e.g., security appliances, security gateways, security services, and/or other security devices) can include various security functions (e.g., firewall, anti-malware, intrusion prevention/detection, proxy, and/or other security functions), networking functions (e.g., routing, Quality of Service (QoS), workload balancing of network related resources, and/or other networking functions), and/or other functions. For example, routing functions can be based on source information (e.g., source IP address and port), destination information (e.g., destination IP address and port), and protocol information.

A basic packet filtering firewall filters network communication traffic by inspecting individual packets transmitted over a network (e.g., packet filtering firewalls or first generation firewalls, which are stateless packet filtering firewalls). Stateless packet filtering firewalls typically inspect the individual packets themselves and apply rules based on the inspected packets (e.g., using a combination of a packet's source and destination address information, protocol information, and a port number).

Application firewalls can also perform application layer filtering (e.g., using application layer filtering firewalls or second generation firewalls, which work on the application level of the TCP/IP stack). Application layer filtering firewalls or application firewalls can generally identify certain applications and protocols (e.g., web browsing using HyperText Transfer Protocol (HTTP), a Domain Name System (DNS) request, a file transfer using File Transfer Protocol (FTP), and various other types of applications and other protocols, such as Telnet, DHCP, TCP, UDP, and TFTP (GSS)). For example, application firewalls can block unauthorized protocols that attempt to communicate over a standard port (e.g., an unauthorized/out of policy protocol attempting to sneak through by using a non-standard port for that protocol can generally be identified using application firewalls).

Stateful firewalls can also perform stateful-based packet inspection in which each packet is examined within the context of a series of packets associated with that network transmission's flow of packets/packet flow (e.g., stateful firewalls or third generation firewalls). This firewall technique is generally referred to as a stateful packet inspection as it maintains records of all connections passing through the firewall and is able to determine whether a packet is the start of a new connection, a part of an existing connection, or is an invalid packet. For example, the state of a connection can itself be one of the criteria that triggers a rule within a policy.

Advanced or next generation firewalls can perform stateless and stateful packet filtering and application layer filtering as discussed above. Next generation firewalls can also perform additional firewall techniques. For example, certain newer firewalls sometimes referred to as advanced or next generation firewalls can also identify users and content. In particular, certain next generation firewalls are expanding the list of applications that these firewalls can automatically identify to thousands of applications. Examples of such next generation firewalls are commercially available from Palo Alto Networks, Inc. (e.g., Palo Alto Networks' PA Series next generation firewalls, Palo Alto Networks' VM Series virtualized next generation firewalls, and CN Series container next generation firewalls).

For example, Palo Alto Networks' next generation firewalls enable enterprises and service providers to identify and control applications, users, and content—not just ports, IP addresses, and packets—using various identification technologies, such as the following: App-ID™ (e.g., App ID) for accurate application identification, User-ID™ (e.g., User ID) for user identification (e.g., by user or user group), and Content-ID™ (e.g., Content ID) for real-time content scanning (e.g., controls web surfing and limits data and file transfers). These identification technologies allow enterprises to securely enable application usage using business-relevant concepts, instead of following the traditional approach offered by traditional port-blocking firewalls. Also, special purpose hardware for next generation firewalls implemented, for example, as dedicated appliances generally provides higher performance levels for application inspection than software executed on general purpose hardware (e.g., such as security appliances provided by Palo Alto Networks, Inc., which utilize dedicated, function specific processing that is tightly integrated with a single-pass software engine to maximize network throughput while minimizing latency for Palo Alto Networks' PA Series next generation firewalls).

Overview of Techniques for Applying Intelligent Security for Zero Trust in Mobile Networks with Perimeter Security Platforms

Technical and security challenges with service provider networks exist for devices in mobile networks (e.g., 4G/LTE, 5G, and later mobile networks).

For example, some mobile network service providers and/or enterprises with private mobile networks prefer to not have security platforms located within their mobile core networks (e.g., 4G/5G core networks).

Moreover, many security operations teams (e.g., Information Technology (IT)/security administrators (admins)) have more comfort and control with perimeter security platform deployments as compared with security platforms being deployed within mobile core networks (e.g., 4G/5G core networks), which can be more complex and/or give rise to other complications and/or technical challenges.

As such, what are needed are new and improved security techniques for devices communicating on such service provider network environments (e.g., mobile networks, including various 4G/LTE, 5G, and later mobile networks).

Specifically, what are needed are new and improved solutions for monitoring such network traffic and applying intelligent security for zero trust in mobile network environments with perimeter security platforms, such as for devices (e.g., UEs) communicating over service provider networks (e.g., including for applying context-based and/or enhanced security in mobile networks based on subscriber-ID/International Mobile Subscriber Identity (IMSI), equipment-ID/International Mobile Equipment Identity (IMEI), Network Slice ID/Single Network Slice Selection Assistance Information (S-NSSAI), IP to mobile subscriber traffic mappings, and/or other context-based information to facilitate enhanced security in such mobile network environments).

Accordingly, the disclosed techniques facilitate a system/process/computer program product for applying intelligent security for zero trust in mobile networks with perimeter security platforms as will now be further described below.

For example, various techniques are disclosed for applying mobile network identities-based intelligent security (e.g., 4G and/or 5G mobile identities) using the Packet Forwarding Control Protocol (PFCP), the Radius protocol, the Diameter protocol, and/or Application Programming Interfaces (APIs) over the perimeter of mobile networks using one or more interfaces, such as the 4G SGi interface and/or the 5G N6 interface as will be further described below.

In some embodiments, a system/process/computer program product for applying intelligent security for zero trust in mobile networks with perimeter security platforms (e.g., using the PFCP protocol) includes deploying a security platform in a 5G and/or 4G/LTE mobile network environment and monitoring PFCP messages at the security platform in a standalone 5G network and/or 4G/LTE network (e.g., with a CUPS architecture). Specifically, the security platform is configured to process PFCP messages including PFCP session establishment request/response messages and/or PFCP session modification request/response messages to extract contextual information, which can include User Equipment (UE) IP, International Mobile Subscription Identity (IMSI)/Subscription Permanent Identifier (SUPI), IME/PEI, S-NSSAI, APN/DNN, and/or RAT Type information. The security platform is further configured to apply a security policy (e.g., enforce one or more security rules) based on the contextual information.

In some embodiments, a system/process/computer program product for applying intelligent security for zero trust in mobile networks with perimeter security platforms (e.g., using the Radius protocol) includes deploying a security platform in a 5G and/or 4G/LTE mobile network environment and monitoring Radius messages at the security platform in a standalone 5G network and/or 4G/LTE network. Specifically, the security platform is configured to process Radius messages including Accounting-Request(START)/Accounting-Response(START) and Accounting-Request(interim-update)/Accounting-Response(interim-update) messages to extract contextual information, which can include UE IP, IMSI, IMEI, APN, RAT Type, and/or user location information (e.g., examples of Attribute Value Pairs (AVPs) required in Radius messages include the following: Framed-IP-Address—IPv4 address of UE; Framed-IPv6-Prefix—IPv6 Prefix assigned to UE; and called-station-id—APN). The security platform is further configured to apply a security policy (e.g., enforce one or more security rules) based on the contextual information.

In some embodiments, a system/process/computer program product for applying intelligent security for zero trust in mobile networks with perimeter security platforms (e.g., using the Diameter protocol) includes deploying a security platform in a 5G and/or 4G/LTE mobile network environment and monitoring Diameter messages at the security platform in a standalone 5G network and/or 4G/LTE network. Specifically, the security platform is configured to process Diameter messages including Accounting-Request(START)/Accounting-Response(START) and Accounting Request (Interim)/Accounting Answer (Interim) messages to extract contextual information, which can include UE IP, IMSI, IMEI, APN, RAT Type, and/or user location information (e.g., examples of Attribute Value Pairs (AVPs) required in Diameter messages include the following: Framed-IP-Address—IPv4 address of UE; Framed-IPv6-Prefix—IPv6 Prefix assigned to UE; and called-station-id—APN). The security platform is further configured to apply a security policy (e.g., enforce one or more security rules) based on the contextual information.

For example, the disclosed techniques for applying intelligent security for zero trust in mobile networks with perimeter security platforms facilitate providing intelligent security (e.g., based on an extracted Subscriber-ID) with an N6 security platform over the perimeter in a 5G mobile network environment.

As another example, the disclosed techniques for applying intelligent security for zero trust in mobile networks with perimeter security platforms facilitate providing intelligent security (e.g., based on an extracted Equipment-ID) with an SGi security platform over the perimeter in a 4G/LTE mobile network environment.

As yet another example, the disclosed techniques for applying intelligent security for zero trust in mobile networks with perimeter security platforms facilitate providing 5G subscriber/user and/or 5G equipment/device level known and unknown threat identification and prevention over the N6 interface in 5G mobile network environments and over the SGi interface in 4G/LTE mobile network environments.

As yet a further example, the disclosed techniques for applying intelligent security for zero trust in mobile networks with perimeter security platforms facilitate providing 5G subscriber/user and/or 5G equipment/device level application security over the N6 interface in 5G mobile network environments and over the SGi interface in 4G/LTE mobile network environments.

As a final example, the disclosed techniques for applying intelligent security for zero trust in mobile networks with perimeter security platforms facilitate providing 5G subscriber/user and/or 5G equipment/device level URL filtering over the N6 interface in 5G mobile network environments and over the SGi interface in 4G/LTE mobile network environments.

Moreover, service providers and enterprises can utilize the disclosed techniques applying security for zero trust in mobile networks with perimeter security platforms in mobile networks to apply subscriber-ID based security over IP-based external network (e.g., similar to the Internet) perimeters.

Accordingly, new and improved security solutions that facilitate applying security (e.g., network-based security) for zero trust in mobile networks with perimeter security platforms in mobile networks (e.g., the security platform can be implemented using a firewall (FW)/Next Generation Firewall (NGFW), a network sensor acting on behalf of the firewall, or another (virtual) device/component that can implement security policies using the disclosed techniques, including, for example, Palo Alto Networks' PA Series next generation firewalls, Palo Alto Networks' VM Series virtualized next generation firewalls, and CN Series container next generation firewalls, and/or other commercially available virtual-based or container-based firewalls can similarly be implemented and configured to perform the disclosed techniques) (e.g., a 4G/5G/later versions of mobile networks) on various interfaces (e.g., SGi, N6, etc.) and protocols (e.g., PFCP, Radius, Diameter, etc.) in mobile network environments are disclosed in accordance with some embodiments.

These and other embodiments and examples for applying intelligent security for zero trust in mobile networks with perimeter security platforms in mobile networks will be further described below.

Example System Architectures for Applying Intelligent Security for Zero Trust in Mobile Networks with Perimeter Security Platforms

Accordingly, in some embodiments, the disclosed techniques for applying intelligent security for zero trust in mobile networks with perimeter security platforms (e.g., the security function(s)/platform(s) can be implemented using a firewall (FW)/Next Generation Firewall (NGFW), a network sensor acting on behalf of the firewall, or another (virtual) device/component that can implement security policies using the disclosed techniques, such as PANOS executing on a virtual/physical NGFW solution commercially available from Palo Alto Networks, Inc. or another security platform/NFGW, including, for example, Palo Alto Networks' PA Series next generation firewalls, Palo Alto Networks' VM Series virtualized next generation firewalls, and CN Series container next generation firewalls, and/or other commercially available virtual-based or container-based firewalls can similarly be implemented and configured to perform the disclosed techniques) are configured to provide DPI capabilities (e.g., including stateful inspection) of, for example, user/subscriber sessions (e.g., user/subscriber traffic) over various interfaces (e.g., RESTful APIs, SGi, N6, and/or other interfaces in a core 4G/LTE, 5G, and later mobile networks) to apply security on traffic in mobile networks based on a policy (e.g., layer-7 security and/or other security policy enforcement) as further described below.

Specifically, as will now be described with respect to various system embodiments, context-based security can be applied using a Security Platform in mobile networks, including 4G/LTE, 5G, and later mobile networks, as will be further described below with respect to various embodiments. In an example implementation, context-based security can be applied using a Security Platform in mobile networks based on one or more of the following: a subscriber/user including IMSI, IMEI, RAT type, Network Slice, DNN/APN, location, user IP, and/or other contextual information. The Security Platform can be deployed on, for example, an SGi and/or Sxb interfaces in a 4G/LTE network and an N4 and/or N6 interfaces in a 5G network.

Applying Intelligent Security for Zero Trust in Mobile Networks with Perimeter Security Platforms Using the PFCP Protocol

Various embodiments for applying intelligent security for zero trust in mobile networks with perimeter security platforms using the PFCP protocol will now be described below.

In an example implementation, applying intelligent security for zero trust in mobile networks with perimeter security platforms using the PFCP protocol includes deploying a security platform in a 5G and/or 4G/LTE mobile network environment and monitoring PFCP messages at the security platform in a standalone 5G network and/or 4G/LTE network (e.g., with a CUPS architecture). Specifically, the security platform is configured to process PFCP messages including PFCP session establishment request/response messages and/or PFCP session modification request/response messages to extract contextual information, which can include User Equipment (UE) IP, International Mobile Subscription Identity (IMSI)/Subscription Permanent Identifier (SUPI), IMEI/PEI, S-NSSAI, APN/DNN, and/or RAT Type information. The security platform is further configured to apply a security policy (e.g., enforce one or more security rules) based on the contextual information.

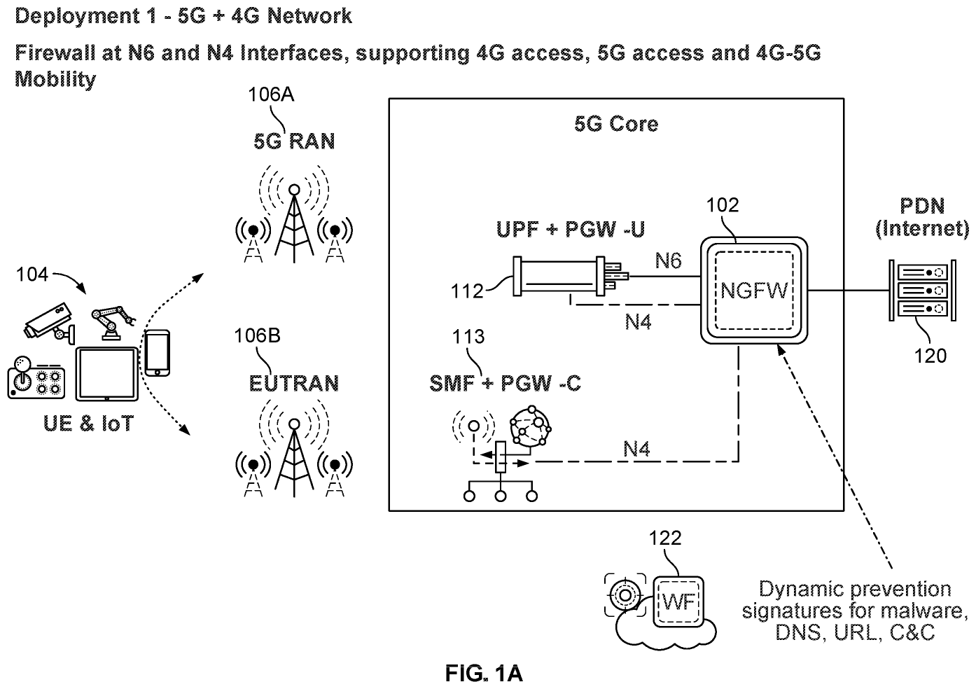

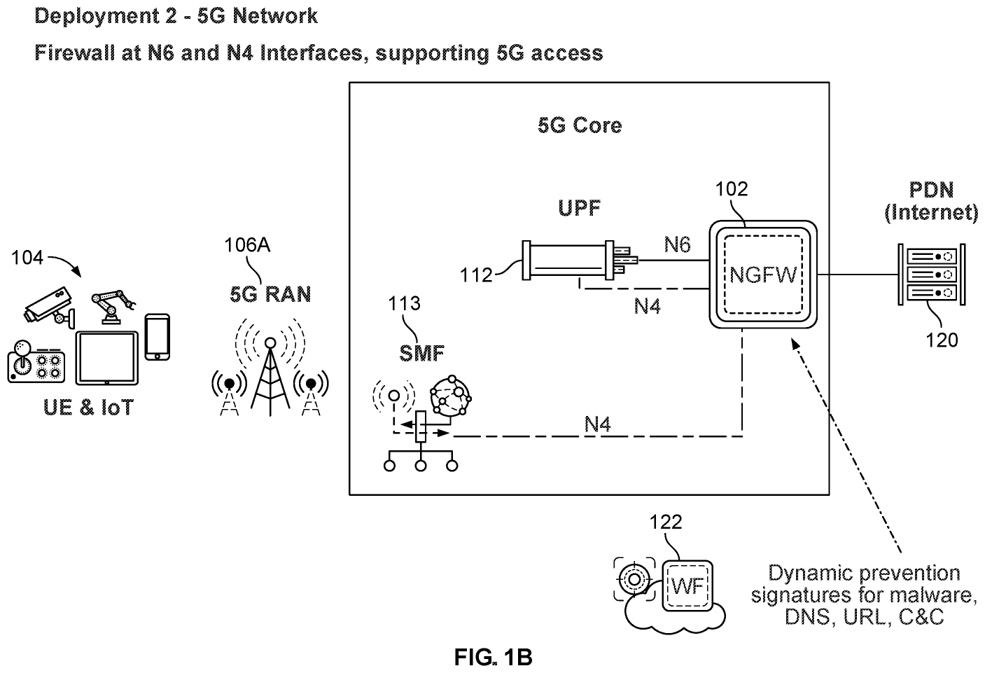

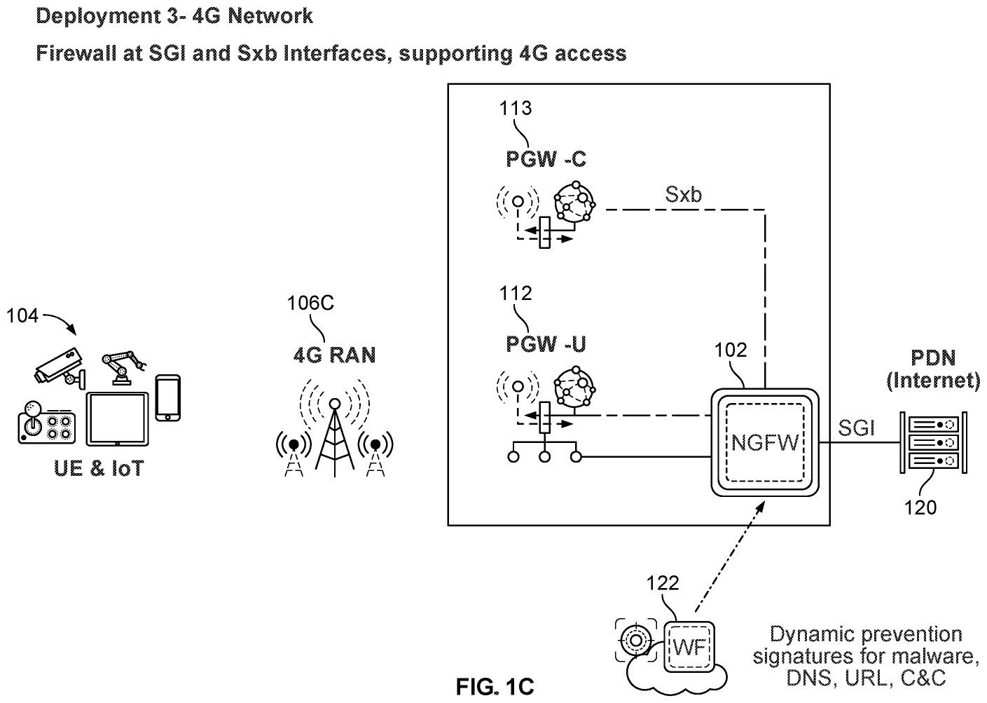

FIG. 1A is a block diagram of a first example service deployment architecture of a 5G and 4G mobile network for applying intelligent security for zero trust in mobile networks with perimeter security platforms using the PFCP protocol in accordance with some embodiments.

Specifically, FIG. 1A is a first example of a service deployment architecture of a 5G and 4G mobile network that includes a Security Platform 102 (e.g., the security function(s)/platform(s) can be implemented using a firewall (FW)/Next Generation Firewall (NGFW), a network sensor acting on behalf of the firewall, or another (virtual) device/component that can implement security policies using the disclosed techniques, including, for example, Palo Alto Networks' PA Series next generation firewalls, Palo Alto Networks' VM Series virtualized next generation firewalls, and CN Series container next generation firewalls, and/or other commercially available virtual-based or container-based firewalls can similarly be implemented and configured to perform the disclosed techniques) for applying context-based security in mobile networks over various interfaces (e.g., SGi and/or other interfaces in a 4G/LTE network, and N6 and/or other interfaces in a 5G network) in mobile networks (e.g., 4G/LTE or later mobile networks) as further described below.

As referred to herein, IMSI is the concept referred to by ITU-T as the “International Mobile Subscription Identity.” IMSI is a 14 or 15 digit number.

As also referred to herein, SUPI is a globally unique 5G “Subscription Permanent Identifier” allocated to each subscriber in the 5G system. As per 3GPP T.S 23.003 version 16.9.0, a SUPI type may indicate an IMSI, a network access identifier (NAI), a Global Line Identifier (GLI), or a Global Cable Identifier (GCI).

As also referred to herein, International Mobile Equipment Identifier (IMEI) is defined in 3GPP TS 23.003 available at https://portal.3gpp.org/desktopmodules/Specifications/SpecificationDetails.aspx?specificationId=729.

As shown in FIG. 1A, the 5G and 4G mobile network environment can also include a 5G Radio Access Network (RAN) access as shown at 106A, EUTRAN access as shown at 106B, and/or other networks including, for example, Wi-Fi access and Fixed access (not shown), to facilitate data communications for subscribers (e.g., using User Equipment (UE), such as smart phones, laptops, computers (which may be in a fixed location), and Internet of Things (IoT) devices and/or other cellular enabled computing devices/equipment as shown at 104, and/or other network communication enabled devices, including over a Packet Data Network (PDN) (e.g., the Internet) 120 to access various applications, web services, content hosts, etc. and/or other networks).

As also shown in FIG. 1A, UPF and PGW-U 112 is in communication with PDN (Internet) 120. Specifically, Security Platform 102 is located on the perimeter of the 5G and 4G mobile network environment between UPF and PGW-U 112 and PDN (Internet) 120 via an N6 interface. Security Platform 102 is also in communication with a Session Management Function (SMF) and Packet Gateway Control Plane (PGW-C) 113 (e.g., in control plane communications with Security Platform 102 via an N4 interface to access UE IP, IMEI, IMSI, and/or other contextual information as will be further described below).

Referring to FIG. 1A, network traffic communications are monitored using Security Platform 102 at N6 and N4 interfaces in which the security platform is located on the perimeter of the 5G and 4G mobile core network. As shown, network traffic communications are monitored/filtered on the perimeter of the 5G and 4G mobile network using Security Platform 102 (e.g., (virtual) devices/appliances that each include a firewall (FW), a network sensor acting on behalf of the firewall, or another device/component that can implement security policies using the disclosed techniques) configured to perform the disclosed techniques for applying context-based security over various interfaces (e.g., N4, N6, and/or other interfaces in the 5G mobile network and SGi (not shown) and/or other interfaces in the 4G mobile network) in mobile networks as similarly described above and as further described below.

In this example implementation, the disclosed techniques for applying at Security Platform 102 can be performed using a security platform deployed at a perimeter of a 4G/LTE and 5G technology-based mobile network, such as shown in FIG. 1A. Specifically, Security Platform 102 can be configured to apply context-based security in mobile networks over various interfaces (e.g., N4, N6, and/or other interfaces in the 5G mobile network and SGi (not shown) and/or other interfaces in the 4G mobile network) in mobile networks (e.g., 4G/LTE or later mobile networks) as further described below.

In some embodiments, Security Platform 102 is further configured to provide the following DPI capabilities: DPI of PFCP traffic over the N6 interface. In an example implementation, the security platform is configured to provide DPI capabilities (e.g., including to identify a UE IP, IMSI/SUPI, IMEI/PEI, S-NSSAI, APN/DNN, and/or RAT Type information, etc.) of, for example, PFCP messages over the N6 and/or other interfaces between UPF and PGW-U 112 and PDN 120 to apply context-based security traffic based on a policy (e.g., layer-7 security and/or other security policy enforcement) as further described below.

Specifically, in this example implementation, the security platform is configured to add an entry of the UE IP and contextual information, such as IMSI, IMEI, S-NSSAI related to this subscriber/user in a data store (not shown) (e.g., a database, such as an SQL or other type of commercially available database). The security platform removes the entry of a UE IP and related contextual information from the database if either of the following events occur based on the monitoring of the PFCP protocol over the N6/SGi interface: (1) a PFCP session deletion request/response message to delete the PFCP control session; and (2) user/subscriber session(s) timeout message (e.g., such timeouts can be configurable).

More specifically, in this example implementation, the security platform is configured to monitor PFCP messages including the following: (1) a PFCP Session Establishment Procedure (e.g., as per 3GPP T.S 29.244 v 18.3.0 (e.g., which is publicly available at https://portal.3gpp.org/desktopmodules/Specifications/SpecificationDetails.aspx?specificationId=3111), a PFCP Session Establishment procedure shall be used to set up a PFCP session between a CP function and a UP function and configure Rules in the UP function so that the UP function can handle incoming packets); (2) a PFCP Session Modification Procedure (e.g., the PFCP Session Modification procedure shall be used to modify an existing PFCP session, e.g., to configure a new rule, to modify an existing rule, to delete an existing rule); and (3) a PFCP Session Deletion Procedure (e.g., the PFCP Session Deletion procedure shall be used to delete an existing PFCP session between the CP function and the UP function) to facilitate extraction of the above-described contextual information.

In addition, Security Platform 102 can also be in network communication with a Cloud Security Service 122 (e.g., a commercially available cloud-based security service, such as the WildFire™ (WF) cloud-based malware analysis environment that is a commercially available cloud security service provided by Palo Alto Networks, Inc., which includes automated security analysis of malware samples as well as security expert analysis, or a similar solution provided by another vendor can be utilized), such as via the Internet. For example, Cloud Security Service 122 can be utilized to provide the security platforms with dynamic prevention signatures for malware, DNS, URLs, CNC malware, and/or other malware as well as to receive malware samples for further security analysis.

FIG. 1B is a block diagram of a second example service deployment architecture of a 5G mobile network service deployment architecture of a 5G and 4G mobile network for applying intelligent security for zero trust in mobile networks with perimeter security platforms using the PFCP protocol in accordance with some embodiments.

Specifically, in this second example of a service deployment architecture of a 5G mobile network with Security Platform 102, network traffic communications are monitored using Security Platform 102 at N6 and N4 interfaces in which the security platform is located on the perimeter of the 5G mobile core network. As shown, network traffic communications are monitored/filtered on the perimeter of the 5G mobile network using Security Platform 102 (e.g., (virtual) devices/appliances that each include a firewall (FW), a network sensor acting on behalf of the firewall, or another device/component that can implement security policies using the disclosed techniques) configured to perform the disclosed techniques for applying context-based security over various interfaces (e.g., N4, N6, and/or other interfaces in the 5G mobile network) in mobile networks as similarly described above and as further described below.

In this example implementation, the disclosed techniques for applying at a Security Platform can be performed using a security platform deployed at a perimeter of a 5G technology-based mobile network, such as shown in FIG. 1B. Specifically, Security Platform 102 can be configured to apply context-based security in mobile networks over various interfaces (e.g., N4 interface via UPF 112 and SMF 113, N6 interface via UPF 112, and/or other interfaces in the 5G mobile network) in mobile networks (e.g., 5G or later mobile networks) as further described below.

In some embodiments, Security Platform 102 is further configured to provide the following DPI capabilities: DPI of PFCP traffic over the N6 interface. In an example implementation, the security platform is configured to provide DPI capabilities (e.g., including to identify a UE IP, IMSI/SUPI, IMEU/PEI, S-NSSAI, APN/DNN, and/or RAT Type information, etc.) of, for example, PFCP messages over the N6 interface and/or other interfaces between UPF and PGW-U 112 and PDN 120 to apply context-based security traffic based on a policy (e.g., layer-7 security and/or other security policy enforcement) as further described below.

FIG. 1C is a block diagram of a third example service deployment architecture of a 4G mobile network service deployment architecture for applying intelligent security for zero trust in mobile networks with perimeter security platforms using the PFCP protocol in accordance with some embodiments.

As shown in FIG. 1C, the 4G mobile network environment can also include a 4G Radio Access Network (RAN) access as shown at 106C and/or other networks including, for example, Wi-Fi access and Fixed access (not shown), to facilitate data communications for subscribers (e.g., using User Equipment (UE), such as smart phones, laptops, computers (which may be in a fixed location), and Internet of Things (IoT) devices and/or other cellular enabled computing devices/equipment as shown at 104, and/or other network communication enabled devices, including over a Packet Data Network (PDN) (e.g., the Internet) 120 to access various applications, web services, content hosts, etc. and/or other networks).

Specifically, in this third example of a service deployment architecture of a 4G mobile network with Security Platform 102, network traffic communications are monitored using Security Platform 102 at SGi and Sxb interfaces in which the security platform is located on the perimeter of the 4G mobile core network. As shown, network traffic communications are monitored/filtered on the perimeter of the 4G mobile network using Security Platform 102 (e.g., (virtual) devices/appliances that each include a firewall (FW), a network sensor acting on behalf of the firewall, or another device/component that can implement security policies using the disclosed techniques) configured to perform the disclosed techniques for applying context-based security over various interfaces (e.g., SGi, Sxb, and/or other interfaces in the 4G mobile network) in mobile networks as similarly described above and as further described below.

In this example implementation, the disclosed techniques for applying at Security Platform 102 can be performed using a security platform deployed at a perimeter of a 4G technology-based mobile network, such as shown in FIG. 1C. Specifically, Security Platform 102 can be configured to apply context-based security in mobile networks over various interfaces (e.g., Sxb interface via PGW-C 113, SGi interface via PGW-U 112 and PDN 120, and/or other interfaces in the 4G mobile network) in mobile networks (e.g., 4G or later mobile networks) as further described below.

In some embodiments, Security Platform 102 is further configured to provide the following DPI capabilities: DPI of PFCP traffic over the N6 interface. In an example implementation, the security platform is configured to provide DPI capabilities (e.g., including to identify a UE IP, IMSI/SUPI, IMEI/PEI, S-NSSAI, APN/DNN, and/or RAT Type information, etc.) of, for example, PFCP messages over the N6 and/or other interfaces between UPF and PGW-U 112 and PDN 120 to apply context-based security traffic based on a policy (e.g., layer-7 security and/or other security policy enforcement) as further described below.

Applying Intelligent Security for Zero Trust in Mobile Networks with Perimeter Security Platforms Using the Radius Protocol

Various embodiments for applying intelligent security for zero trust in mobile networks with perimeter security platforms using the Radius protocol will now be described below.

In an example implementation, applying intelligent security for zero trust in mobile networks with perimeter security platforms using the Radius protocol includes deploying a security platform in a 5G and/or 4G/LTE mobile network environment and monitoring Radius messages at the security platform in a standalone 5G network and/or 4G/LTE network. Specifically, the security platform is configured to process Radius messages including Accounting-Request(START)/Accounting-Response(START) and Accounting-Request(interim-update)/Accounting-Response(interim-update) messages to extract contextual information, which can include UE IP, IMSI, IMEI, APN, RAT Type, and/or user location information (e.g., examples of Attribute Value Pairs (AVPs) required in Radius messages include the following: Framed-IP-Address—IPv4 address of UE; Framed-IPv6-Prefix—IPv6 Prefix assigned to UE; and called-station-id—APN). The security platform is further configured to apply a security policy (e.g., enforce one or more security rules) based on the contextual information.

Example Vendor Specific Attributes (VSAs) include the following: (1) 3GPP-IMSI; (2) 3GPP-IMEISV; (3) 3GPP-RAT-Type; and (4) 3GPP-User-LocationInfo.

Specifically, in this example implementation, the security platform is configured to add an entry of the UE IP and contextual information, such as IMSI, IMEI, and APN related to this subscriber/user in a data store (not shown) (e.g., a database, such as an SQL or other type of commercially available database). The security platform removes the entry of a UE IP and related contextual information from the database if either of the following events occur based on the monitoring of the Radius protocol over the N6/SGi interface: (1) an Accounting-Request(STOP)/Accounting-Response(STOP) message is observed/received; and (2) user/subscriber session(s) timeout message (e.g., such timeouts can be configurable) is observed/received.

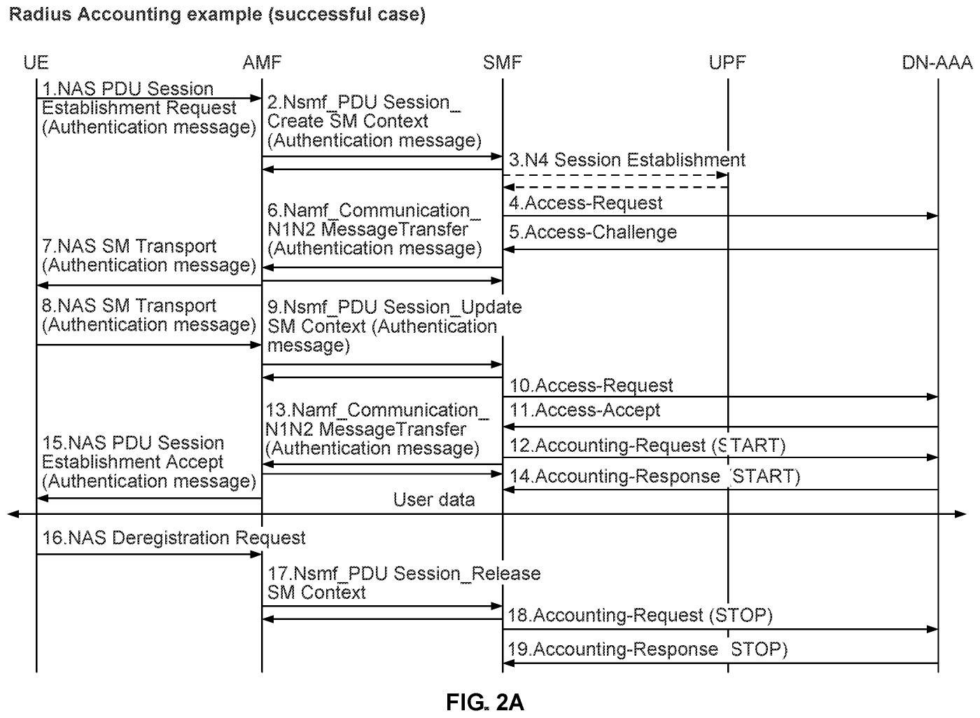

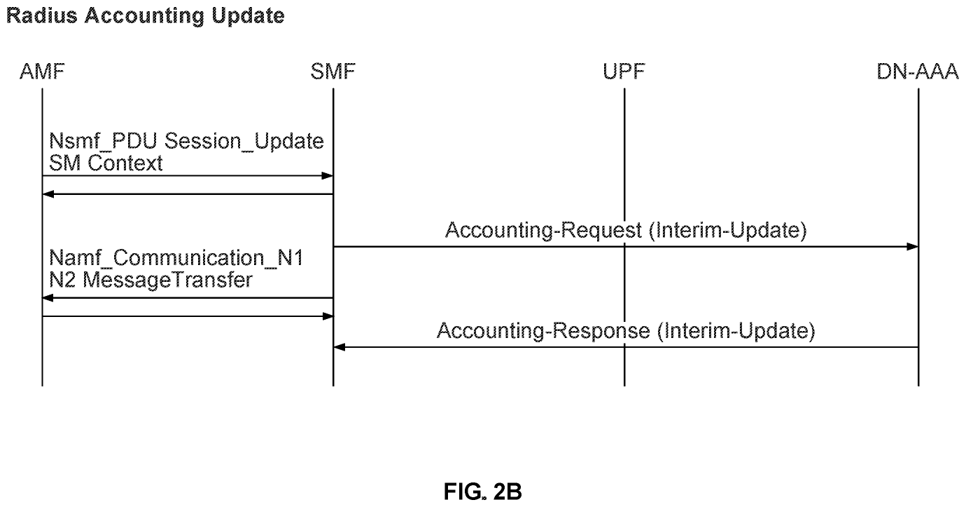

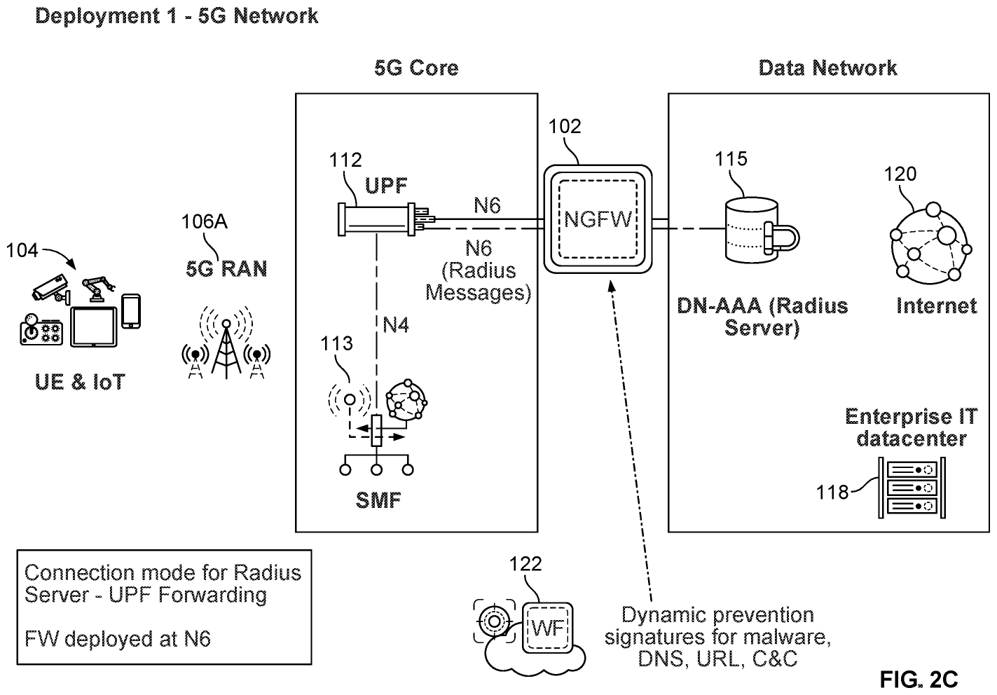

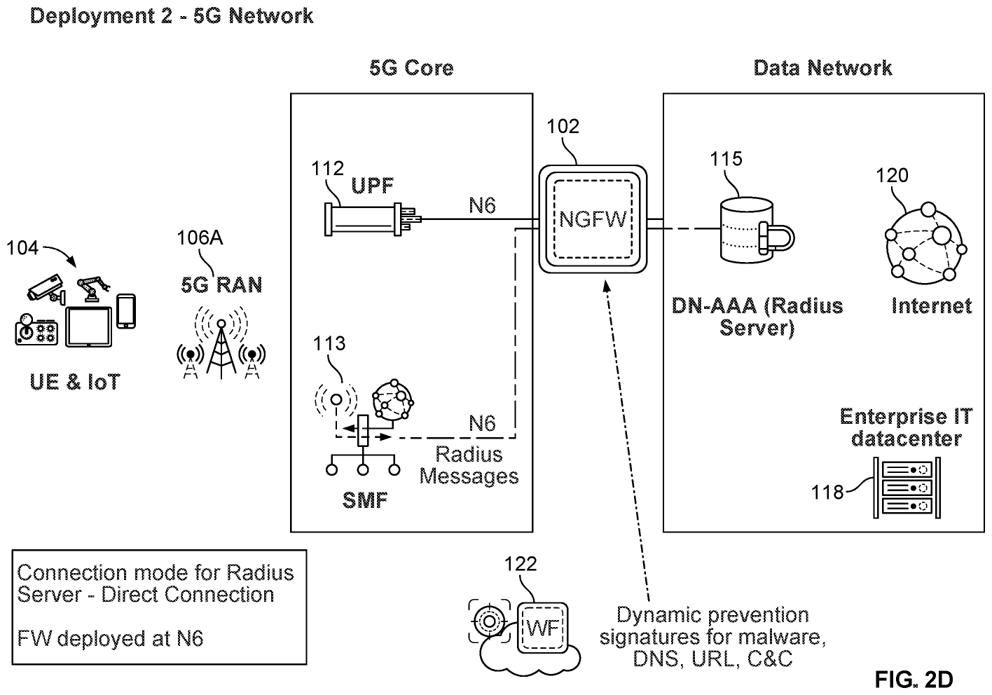

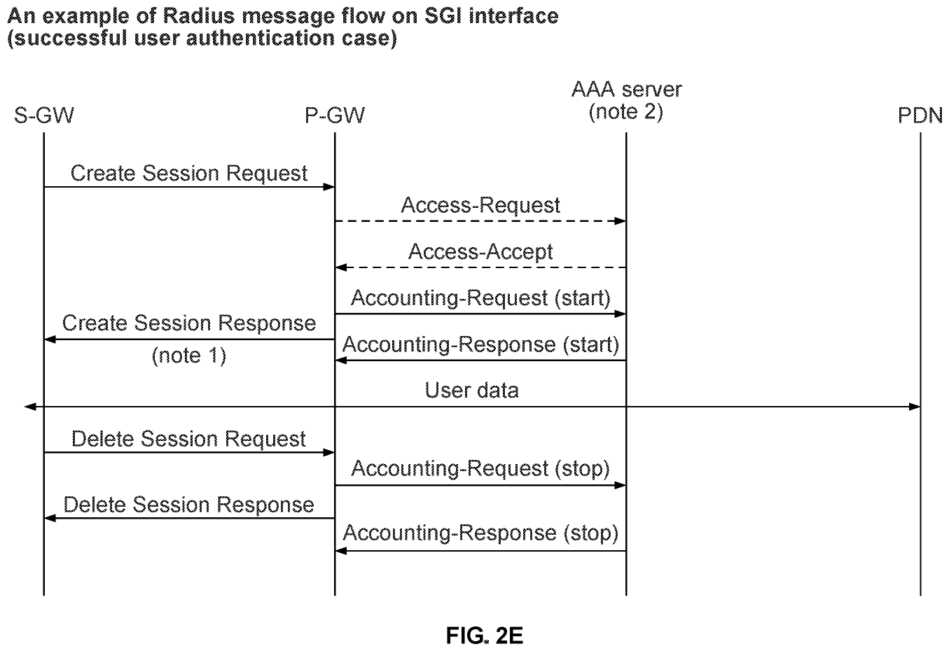

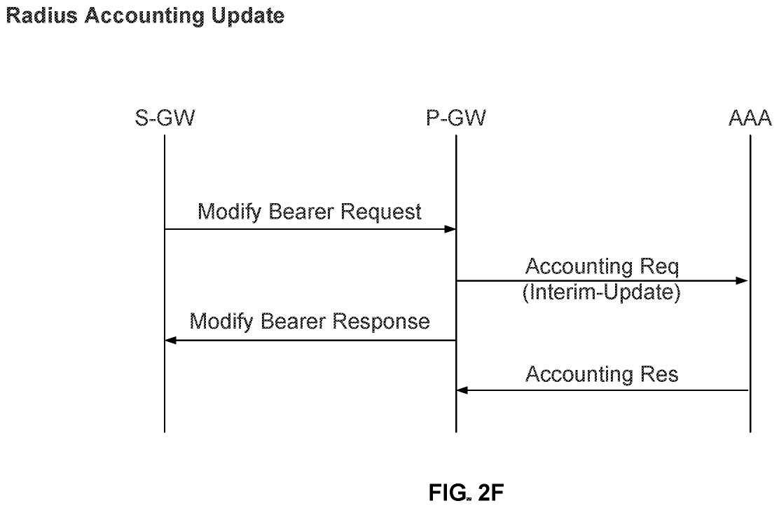

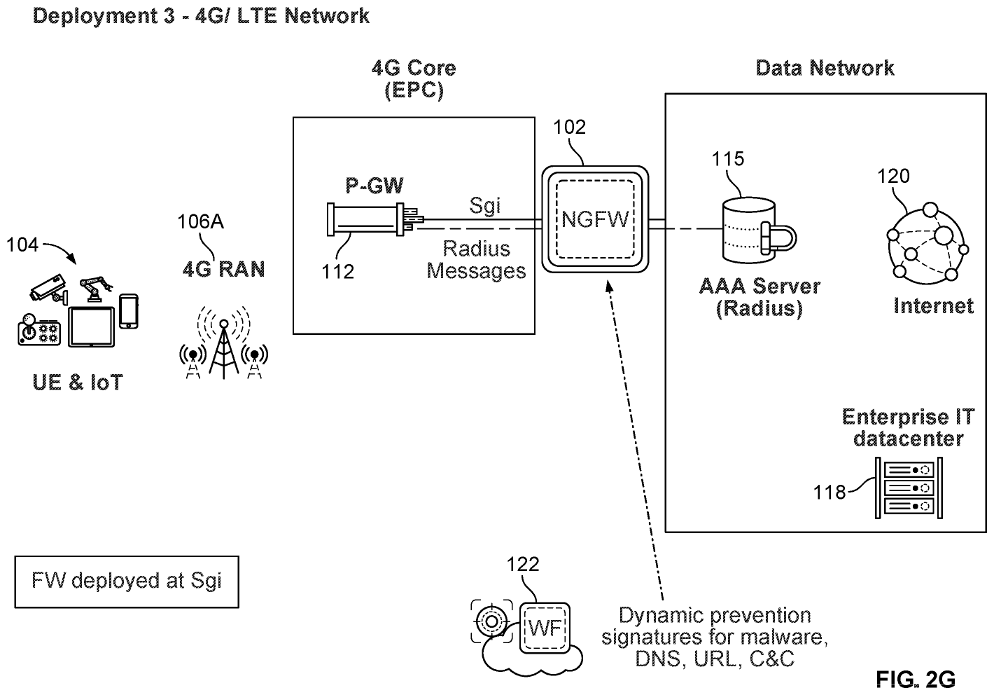

FIG. 2A is a protocol diagram of Radius accounting message flow in a 5G network in accordance with some embodiments.

As per 3GPP TS 29.561 version 17.9.0 Release 17 (e.g., which is publicly available at https://www.etsi.org/deliver/etsi_ts/129500_129599/129561/17.09.00_60/ts_129561v170900p.p df), RADIUS Accounting shall be used according to IETF RFC 2866, IETF RFC 3162, and IETF RFC 4818. The RADIUS accounting client function may reside in an SMF. The RADIUS accounting client may send information to a DN-AAA server, which is identified during the DNN provisioning. The DN-AAA server may store this information and use it to automatically identify the user. This information can be trusted because the 3GPP network has authenticated the subscriber (i.e., USIM card and possibly other authentication methods).

FIG. 2B is a protocol diagram of Radius accounting update message flow in a 5G network in accordance with some embodiments.

FIG. 2C is a block diagram of a first example service deployment architecture of a 5G mobile network for applying intelligent security for zero trust in mobile networks with perimeter security platforms using the Radius protocol in accordance with some embodiments.

Specifically, FIG. 2C is a first example of a service deployment architecture of a 5G and 4G mobile network that includes a Security Platform 102 (e.g., the security function(s)/platform(s) can be implemented using a firewall (FW)/Next Generation Firewall (NGFW), a network sensor acting on behalf of the firewall, or another (virtual) device/component that can implement security policies using the disclosed techniques, including, for example, Palo Alto Networks' PA Series next generation firewalls, Palo Alto Networks' VM Series virtualized next generation firewalls, and CN Series container next generation firewalls, and/or other commercially available virtual-based or container-based firewalls can similarly be implemented and configured to perform the disclosed techniques) for applying context-based security in mobile networks over various interfaces (e.g., SGi and/or other interfaces in a 4G/LTE network, and N6 and/or other interfaces in a 5G network) in mobile networks (e.g., 4G/LTE or later mobile networks) as further described below.

As shown in FIG. 2C, the 5G network environment can also include a 5G Radio Access Network (RAN) access as shown at 106A and/or other networks including, for example, Wi-Fi access and Fixed access (not shown), to facilitate data communications for subscribers (e.g., using User Equipment (UE), such as smart phones, laptops, computers (which may be in a fixed location), and Internet of Things (IoT) devices and/or other cellular enabled computing devices/equipment as shown at 104, and/or other network communication enabled devices, including over a Packet Data Network (PDN)(e.g., the Internet) 120 to access various applications, web services, content hosts, etc. and/or other networks).

As also shown in FIG. 2C, UPF 112 is in communication with a DN-AAA (Radius Server) 115 of a Data Network that also includes an Enterprise IT data center 118 and Internet 120. Specifically, Security Platform 102 is located on the perimeter of the 5G mobile network environment between UPF 112 and DN-AAA (Radius Server) 115 of the Data Network via an N6 interface (e.g., including Radius Messages over the N6 interface). UPF 112 is also in communication with SMF 113 (e.g., in control plane communications with Security Platform 102 via an N4 interface to access UE IP, IMEI, IMSI, and/or other contextual information as will be further described below).

Referring to FIG. 2C, network traffic communications are monitored using Security Platform 102 at N6 and N4 interfaces in which the security platform is located on the perimeter of the 5G mobile core network. As shown, network traffic communications are monitored/filtered on the perimeter of the 5G mobile network using Security Platform 102 (e.g., (virtual) devices/appliances that each include a firewall (FW), a network sensor acting on behalf of the firewall, or another device/component that can implement security policies using the disclosed techniques) configured to perform the disclosed techniques for applying context-based security over various interfaces (e.g., N4, N6, and/or other interfaces in the 5G mobile network and SGi (not shown) and/or other interfaces in the 4G mobile network) in mobile networks as similarly described above and as further described below.

In this example implementation, the disclosed techniques for applying at a Security Platform can be performed using a security platform deployed at a perimeter of a 5G technology-based mobile network, such as shown in FIG. 2C. Specifically, Security Platform 102 can be configured to apply context-based security in mobile networks over various interfaces (e.g., N4, N6, and/or other interfaces in the 5G mobile network and SGi (not shown) and/or other interfaces in the 4G mobile network) in mobile networks (e.g., 4G/LTE or later mobile networks) as further described below.

In some embodiments, Security Platform 102 is further configured to provide the following DPI capabilities: DPI of Radius traffic over the N6 interface. In an example implementation, the security platform is configured to provide DPI capabilities (e.g., including to identify a UE IP, IMSI/SUPI, IMEI/PEI, S-NSSAI, APN/DNN, and/or RAT Type information, etc.) of, for example, Radius messages over the N6 and/or other interfaces between UPF and DN-AAA (Radius Server) 115 to apply context-based security traffic based on a policy (e.g., layer-7 security and/or other security policy enforcement) as further described below.

Specifically, in this example implementation, the security platform is configured to monitor and process Radius messages including Accounting-Request(START)/Accounting-Response(START) and Accounting-Request(interim-update)/Accounting-Response(interim-update) messages to extract contextual information, which can include UE IP, IMSI, IMEI, APN, RAT Type, and/or user location information (e.g., examples of Attribute Value Pairs (AVPs) required in Radius messages include the following: Framed-IP-Address—IPv4 address of UE; Framed-IPv6-Prefix—IPv6 Prefix assigned to UE; and called-station-id—APN). The security platform is further configured to apply a security policy (e.g., enforce one or more security rules) based on the contextual information.

More specifically, in this example implementation, the security platform is configured to add an entry of the UE IP and contextual information, such as IMSI, IMEI, and APN related to this subscriber/user in a data store (not shown)(e.g., a database, such as an SQL or other type of commercially available database). The security platform removes the entry of a UE IP and related contextual information from the database if either of the following events occur based on the monitoring of the Radius protocol over the N6/SGi interface. (1) an Accounting-Request(STOP)/Accounting-Response(STOP) message is observed/received; and (2) user/subscriber session(s) timeout message (e.g., such timeouts can be configurable) is observed/received.

In addition, Security Platform 102 can also be in network communication with a Cloud Security Service 122 (e.g., a commercially available cloud-based security service, such as the WildFire™ (WF) cloud-based malware analysis environment that is a commercially available cloud security service provided by Palo Alto Networks, Inc., which includes automated security analysis of malware samples as well as security expert analysis, or a similar solution provided by another vendor can be utilized), such as via the Internet. For example, Cloud Security Service 122 can be utilized to provide the security platforms with dynamic prevention signatures for malware, DNS, URLs, CNC malware, and/or other malware as well as to receive malware samples for further security analysis.

FIG. 2D is a block diagram of a second example service deployment architecture of a 5G mobile network for applying intelligent security for zero trust in mobile networks with perimeter security platforms using the Radius protocol in accordance with some embodiments.

Specifically, in this second example of a service deployment architecture of a 5G mobile network with Security Platform 102, network traffic communications are monitored using Security Platform 102 at the N6 interfaces in which the security platform is located on the perimeter of the 5G mobile core network as similarly described above in FIG. 2C. As shown, network traffic communications are monitored/filtered on the perimeter of the 5G mobile network using Security Platform 102 (e.g., (virtual) devices/appliances that each include a firewall (FW), a network sensor acting on behalf of the firewall, or another device/component that can implement security policies using the disclosed techniques) configured to perform the disclosed techniques for applying context-based security over various interfaces (e.g., N4, N6, and/or other interfaces in the 5G mobile network and SGi (not shown) and/or other interfaces in the 4G mobile network) in mobile networks as similarly described above and as further described below.

In this example implementation, the disclosed techniques for applying at a Security Platform can be performed using a security platform deployed at a perimeter of a 5G technology-based mobile network, such as shown in FIG. 2D. Specifically, Security Platform 102 can be configured to apply context-based security in mobile networks over various interfaces (e.g., N6 interface via UPF 112 and SMF 113 and/or other interfaces in the 5G mobile network) in mobile networks (e.g., 5G or later mobile networks) as further described below.

In some embodiments, Security Platform 102 is further configured to provide the following DPI capabilities: DPI of Radius traffic over the N6 interface. In an example implementation, the security platform is configured to provide DPI capabilities (e.g., including to identify a UE IP, IMSI, IMEI, APN, RAT Type, and/or user location information (e.g., examples of Attribute Value Pairs (AVPs) required in Radius messages include the following: Framed-IP-Address—IPv4 address of UE; Framed-IPv6-Prefix—IPv6 Prefix assigned to UE; and called-station-id—APN, etc.) of, for example, Radius messages over the N6 interface and/or other interfaces between UPF 112 and DN-AAA (Radius Server) 115 of the Data Network to apply context-based security traffic based on a policy (e.g., layer-7 security and/or other security policy enforcement)) as further described below.

FIG. 2E is a protocol diagram of Radius message flow in a 4G/LTE network in accordance with some embodiments.

As per 3GPP TS 29.061 version 17.6.0 Release 17 (e.g., which is publicly available at https://www.etsi.org/deliver/etsi_ts/129000_129099/129061/17.06.00_60/ts_129061v170600p.p df), RADIUS Accounting shall be used according to IETF RFC 2866, IETF RFC 2869, IETF RFC 3162, and IETF RFC 4818. The RADIUS accounting client function may reside in a GGSN/P-GW. The RADIUS accounting client may send information to an accounting server, which is identified during the APN provisioning. The accounting server may store this information and use it to automatically identify the user. This information can be trusted because the Packet Domain network has authenticated the subscriber (i.e., SIM card and possibly other authentication methods).

FIG. 2F is a protocol diagram of Radius accounting update message flow in a 4G/LTE network in accordance with some embodiments.

FIG. 2G is a block diagram of a first example service deployment architecture of a 4G mobile network for applying intelligent security for zero trust in mobile networks with perimeter security platforms using the Radius protocol in accordance with some embodiments.

Specifically, in this first example of a service deployment architecture of a 4G mobile network with Security Platform 102, network traffic communications are monitored using Security Platform 102 at the SGi interface in which the security platform is located on the perimeter of the 4G mobile core network. As shown, network traffic communications are monitored/filtered on the perimeter of the 4G mobile network using Security Platform 102 (e.g., (virtual) devices/appliances that each include a firewall (FW), a network sensor acting on behalf of the firewall, or another device/component that can implement security policies using the disclosed techniques) configured to perform the disclosed techniques for applying context-based security over various interfaces (e.g., SGi, Sxb, and/or other interfaces in the 4G mobile network) in mobile networks as similarly described above and as further described below.

In this example implementation, the disclosed techniques for applying at a Security Platform can be performed using a security platform deployed at a perimeter of a 4G technology-based mobile network, such as shown in FIG. 2G. Specifically, Security Platform 102 can be configured to apply context-based security in mobile networks over various interfaces (e.g., SGi interface via P-GW 112 and DN-AAA (Radius Server) 115 of the Data Network, and/or other interfaces in the 4G mobile network) in mobile networks (e.g., 4G or later mobile networks) as further described below.

In some embodiments, Security Platform 102 is further configured to provide the following DPI capabilities: DPI of Radius traffic over the SGi interface. In an example implementation, the security platform is configured to provide DPI capabilities (e.g., including to identify a UE IP, IMSI, IMEI, APN, RAT Type, and/or user location information (e.g., examples of Attribute Value Pairs (AVPs) required in Radius messages include the following: Framed-IP-Address—IPv4 address of UE; Framed-IPv6-Prefix—IPv6 Prefix assigned to UE; and called-station-id—APN, etc.) of, for example, Radius messages over the SGi interface and/or other interfaces between P-GW 112 and DN-AAA (Radius Server) 115 of the Data Network to apply context-based security traffic based on a policy (e.g., layer-7 security and/or other security policy enforcement)) as further described below.

Applying Intelligent Security for Zero Trust in Mobile Networks with Perimeter Security Platforms Using the Diameter Protocol

Various embodiments for applying intelligent security for zero trust in mobile networks with perimeter security platforms using the Diameter protocol will now be described below.

In an example implementation, applying intelligent security for zero trust in mobile networks with perimeter security platforms using the Diameter protocol includes deploying a security platform in a 5G and/or 4G/LTE mobile network environment, and monitoring Diameter messages at the security platform in a standalone 5G network and/or 4G/LTE network. Specifically, the security platform is configured to process Diameter messages including Accounting-Request(START)/Accounting-Response(START) and Accounting Request (Interim)/Accounting Answer (Interim) messages to extract contextual information, which can include UE IP, IMSI, IMEI, APN, RAT Type, and/or user location information (e.g., examples of Attribute Value Pairs (AVPs) required in Diameter messages include the following. Framed-IP-Address—IPv4 address of UE; Framed-IPv6-Prefix—IPv6 Prefix assigned to UE; and called-station-id—APN). The security platform is further configured to apply a security policy (e.g., enforce one or more security rules) based on the contextual information.

Specifically, in this example implementation, the security platform is deployed in the perimeter of a 5G and 4G/LTE network, a standalone 5G network, or 4G/LTE network environment and is configured to monitor Diameter messages.

More specifically, the security platform is configured to process Diameter messages including Accounting-Request(START)/Accounting-Response(START) and Accounting Request (Interim)/Accounting Answer (Interim) messages to extract contextual information including, for example, UE IP, IMSI, IMEI, APN, RAT Type, and/or User location. Examples of Attribute Value Pairs (AVPs) required in Diameter messages include the following: (1) Framed-IP-Address—IPv4 address of UE; (2) Framed-IPv6-Prefix—IPv6 Prefix assigned to UE; and (3) called-station-id—APN. The security platform is further configured to apply a security policy (e.g., enforce one or more security rules) based on the contextual information.

Example Vendor Specific Attributes (VSAs) include the following: (1) 3GPP-IMSI; (2) 3GPP-IMEISV; (3) 3GPP-RAT-Type; and (4) 3GPP-User-LocationInfo.

Specifically, in this example implementation, the security platform is configured to add an entry of the UE IP and contextual information, such as IMSI, IMEI, and APN related to this subscriber/user in a data store (not shown) (e.g., a database, such as an SQL or other type of commercially available database). The security platform removes the entry of a UE IP and related contextual information from the database if either of the following events occur based on the monitoring of the Radius protocol over the N6/SGi interface: (1) a Receive Accounting-Request(STOP)/Accounting-Response(STOP) message is observed/received; and (2) user/subscriber session(s) timeout message (e.g., such timeouts can be configurable) is observed/received.

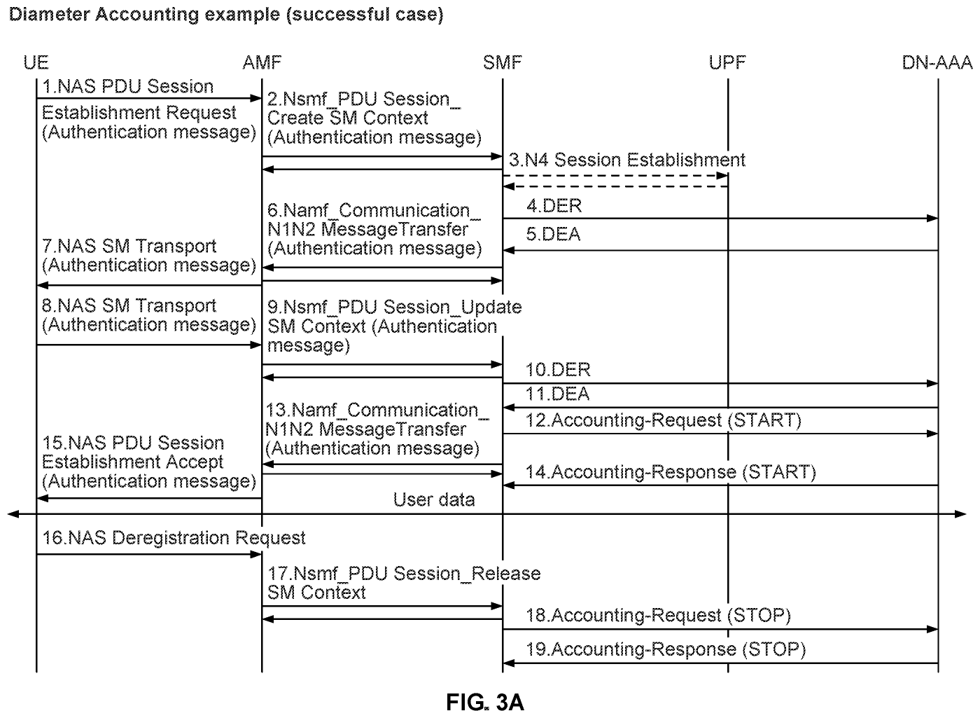

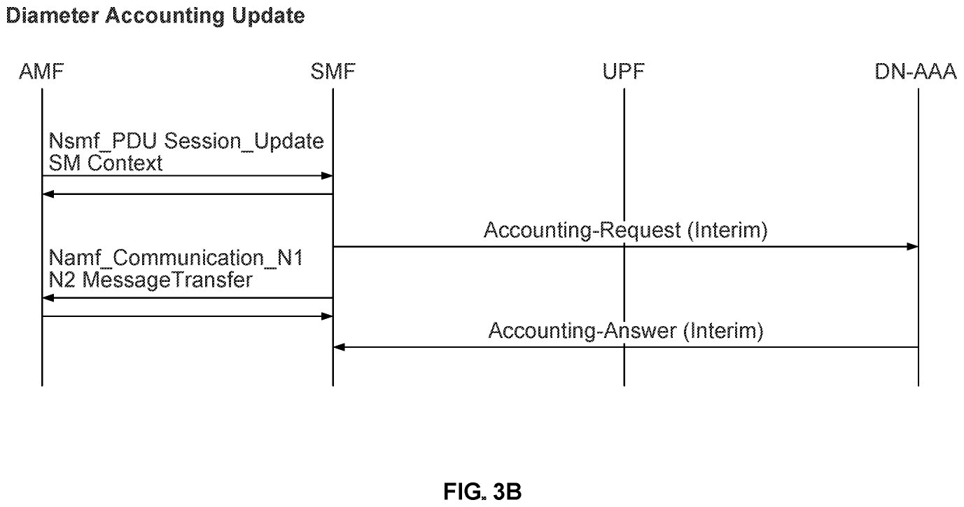

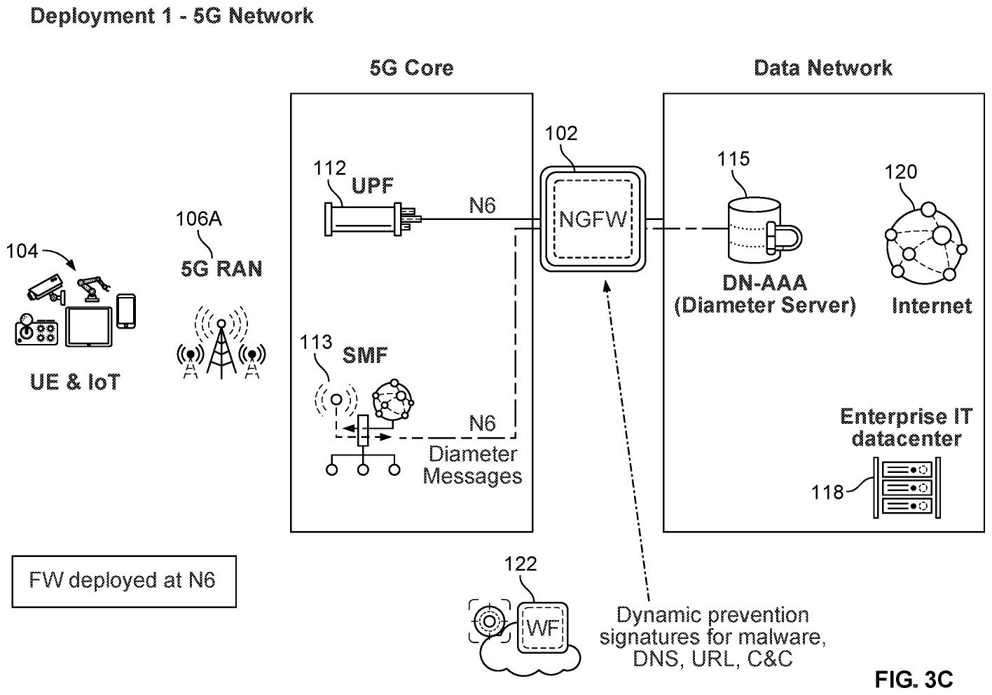

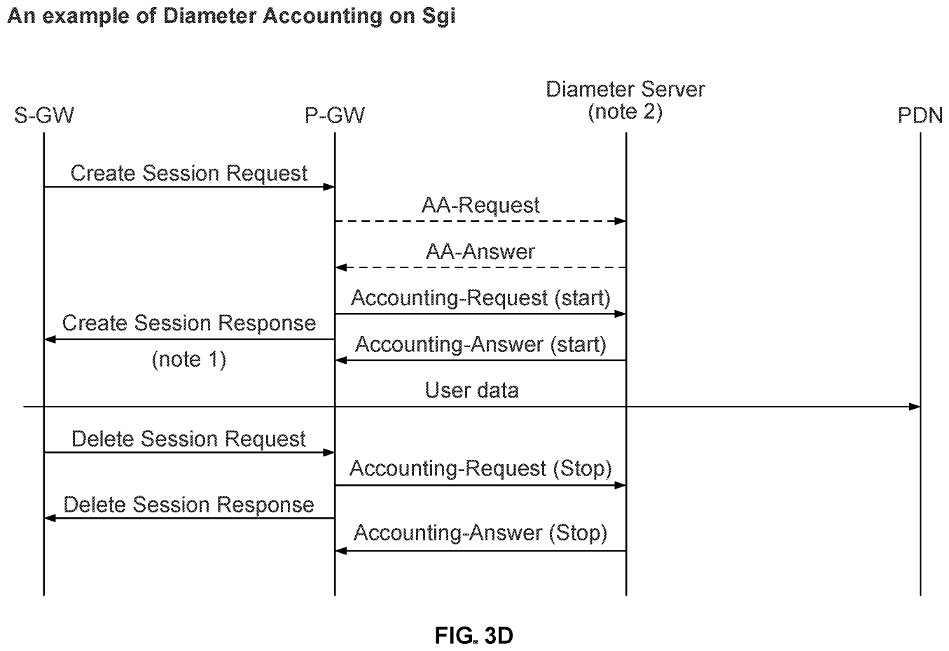

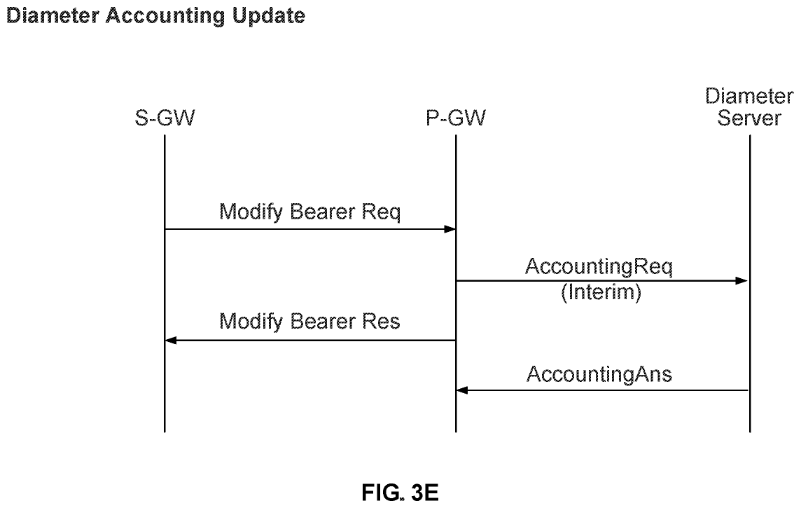

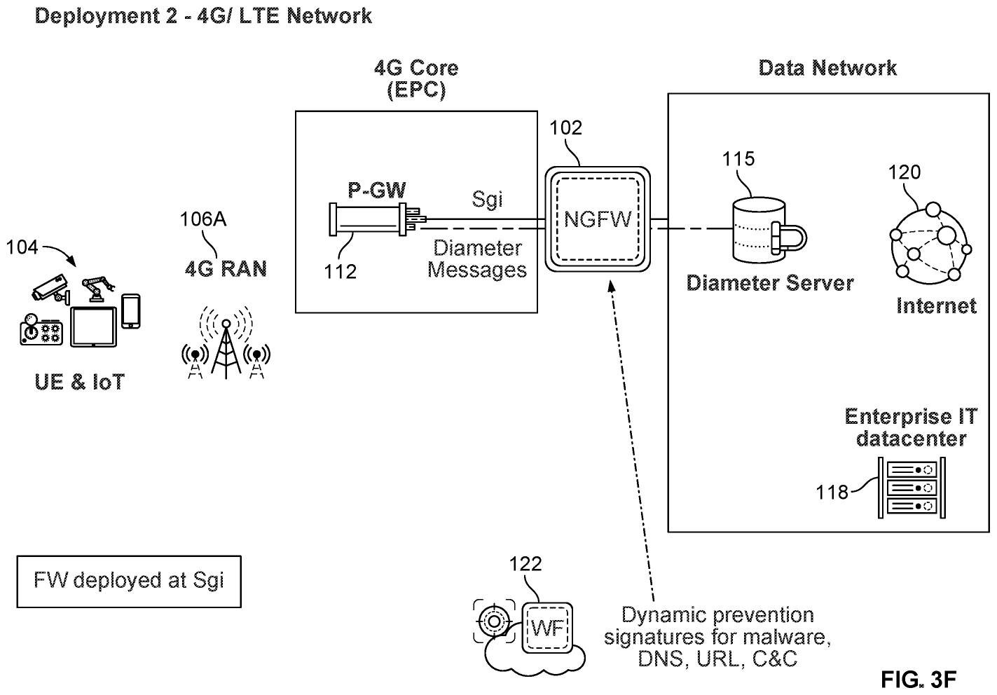

FIG. 3A is a protocol diagram of Diameter accounting message flow in a 5G network in accordance with some embodiments.

FIG. 3B is a protocol diagram of Radius accounting update message flow in a 5G network in accordance with some embodiments.

FIG. 3C is a block diagram of a first example service deployment architecture of a 5G mobile network for applying intelligent security for zero trust in mobile networks with perimeter security platforms using the Diameter protocol in accordance with some embodiments.

Specifically, FIG. 3C is a first example of a service deployment architecture of a 5G mobile network that includes a Security Platform 102 (e.g., the security function(s)/platform(s) can be implemented using a firewall (FW)/Next Generation Firewall (NGFW), a network sensor acting on behalf of the firewall, or another (virtual) device/component that can implement security policies using the disclosed techniques, including, for example, Palo Alto Networks' PA Series next generation firewalls, Palo Alto Networks' VM Series virtualized next generation firewalls, and CN Series container next generation firewalls, and/or other commercially available virtual-based or container-based firewalls can similarly be implemented and configured to perform the disclosed techniques) for applying context-based security in mobile networks over various interfaces (e.g., SGi and/or other interfaces in a 4G/LTE network, and N6 and/or other interfaces in a 5G network) in mobile networks (e.g., 4G/LTE or later mobile networks) as further described below.

As shown in FIG. 3C, the 5G network environment can also include a 5G Radio Access Network (RAN) access as shown at 106A and/or other networks including, for example, Wi-Fi access and Fixed access (not shown), to facilitate data communications for subscribers (e.g., using User Equipment (UE), such as smart phones, laptops, computers (which may be in a fixed location), and Internet of Things (IoT) devices and/or other cellular enabled computing devices/equipment as shown at 104, and/or other network communication enabled devices, including over a Packet Data Network (PDN)(e.g., the Internet) 120 to access various applications, web services, content hosts, etc. and/or other networks).

As also shown in FIG. 3C, UPF 112 is in communication with a DN-AAA (Radius Server) 115 of a Data Network that also includes an Enterprise IT data center 118 and Internet 120. Specifically, Security Platform 102 is located on the perimeter of the 5G mobile network environment between UPF 112 and DN-AAA (Diameter Server) 115 of the Data Network via an N6 interface (e.g., including Diameter Messages over the N6 interface). Security Platform 102 is also in communication with SMF 113 via an N6 interface (e.g., including Diameter Messages over the N6 interface).

Referring to FIG. 3C, network traffic communications are monitored using Security Platform 102 at the N6 interfaces in which the security platform is located on the perimeter of the 5G mobile core network. As shown, network traffic communications are monitored/filtered on the perimeter of the 5G mobile network using Security Platform 102 (e.g., (virtual) devices/appliances that each include a firewall (FW), a network sensor acting on behalf of the firewall, or another device/component that can implement security policies using the disclosed techniques) configured to perform the disclosed techniques for applying context-based security over various interfaces (e.g., N6, and/or other interfaces in the 5G mobile network and SGi (not shown) and/or other interfaces in the 4G mobile network) in mobile networks as similarly described above and as further described below.

In this example implementation, the disclosed techniques for applying at a Security Platform can be performed using a security platform deployed at a perimeter of a 5G technology-based mobile network, such as shown in FIG. 3C. Specifically, Security Platform 102 can be configured to apply context-based security in mobile networks over various interfaces (e.g., N6, and/or other interfaces in the 5G mobile network and SGi (not shown) and/or other interfaces in the 4G mobile network) in mobile networks (e.g., 4G/LTE or later mobile networks) as further described below.

In some embodiments, Security Platform 102 is further configured to provide the following DPI capabilities: DPI of Diameter traffic over the N6 interface. In an example implementation, the security platform is configured to provide DPI capabilities (e.g., including to identify a UE IP, IMSI, IMEI, APN, RAT Type, and/or User location, etc.) of, for example, Diameter messages over the N6 and/or other interfaces between UPF/SMF and DN-AAA (Diameter Server) 115 to apply context-based security traffic based on a policy (e.g., layer-7 security and/or other security policy enforcement) as further described below.

Specifically, in this example implementation, the security platform is deployed in the perimeter of a 5G and 4G/LTE network, a standalone 5G network, or 4G/LTE network environment and is configured to monitor Diameter messages.

More specifically, in this example implementation, the security platform is configured to add an entry of the UE IP and contextual information, such as IMSI, IMEI, and APN related to this subscriber/user in a data store (not shown)(e.g., a database, such as an SQL or other type of commercially available database). The security platform removes the entry of a UE IP and related contextual information from the database if either of the following events occur based on the monitoring of the Radius protocol over the N6/SGi interface: (1) a Receive Accounting-Request(STOP)/Accounting-Response(STOP) message is observed/received; and (2) user/subscriber session(s) timeout message (e.g., such timeouts can be configurable) is observed/received.

In addition, Security Platform 102 can also be in network communication with a Cloud Security Service 122 (e.g., a commercially available cloud-based security service, such as the WildFire™ (WF) cloud-based malware analysis environment that is a commercially available cloud security service provided by Palo Alto Networks, Inc., which includes automated security analysis of malware samples as well as security expert analysis, or a similar solution provided by another vendor can be utilized), such as via the Internet. For example, Cloud Security Service 122 can be utilized to provide the security platforms with dynamic prevention signatures for malware, DNS, URLs, CNC malware, and/or other malware as well as to receive malware samples for further security analysis.

FIG. 3D is a protocol diagram of Diameter accounting message flow on an SGi interface in a 4G/LTE network in accordance with some embodiments.

As per 3GPP TS 29.061 version 17.6.0 Release 17 (e.g., which is publicly available at https://www.etsi.org/deliver/etsi_ts/129000_129099/129061/17.06.00_60/ts_129061v170600p.p df), Diameter Accounting shall be used according to RFC 7155. The Diameter accounting client function may reside in a P-GW. The Diameter accounting client may send information to an accounting server, which is identified during the APN provisioning. The accounting server may store this information and use it to automatically identify the user. This information can be trusted because the PS access network has authenticated the subscriber (i.e., SIM card and possibly other authentication methods).

FIG. 3E is a protocol diagram of Diameter accounting update message flow in a 4G/LTE network in accordance with some embodiments.

FIG. 3F is a block diagram of a first example service deployment architecture of a 4G mobile network for applying intelligent security for zero trust in mobile networks with perimeter security platforms using the Diameter protocol in accordance with some embodiments.

Specifically, in this first example of a service deployment architecture of a 4G mobile network with Security Platform 102, network traffic communications are monitored using Security Platform 102 at the SGi interface in which the security platform is located on the perimeter of the 4G mobile core network. As shown, network traffic communications are monitored/filtered on the perimeter of the 4G mobile network using Security Platform 102 (e.g., (virtual) devices/appliances that each include a firewall (FW), a network sensor acting on behalf of the firewall, or another device/component that can implement security policies using the disclosed techniques) configured to perform the disclosed techniques for applying context-based security over various interfaces (e.g., SGi (as shown in FIG. 3F), Gx, Gy, and/or Sd (e.g., Gx, Gy, and/or Sd interfaces can be used by various Deep Packet Inspection (DPI) solutions for various use cases, including non-security use cases, such as Quality of Service (QoS), Bandwidth management, and/or for subscriber correlation and management, etc.), and/or other interfaces in the 4G mobile network) in mobile networks as similarly described above and as further described below.

In this example implementation, the disclosed techniques for applying at a Security Platform can be performed using a security platform deployed at a perimeter of a 4G technology-based mobile network, such as shown in FIG. 3F. Specifically, Security Platform 102 can be configured to apply context-based security in mobile networks over various interfaces (e.g., SGi interface via P-GW 112 and Diameter Server 115 of the Data Network, and/or other interfaces in the 4G mobile network) in mobile networks (e.g., 4G or later mobile networks) as further described below.

In some embodiments, Security Platform 102 is further configured to provide the following DPI capabilities: DPI of Diameter traffic over the SGi interface. In an example implementation, the security platform is configured to provide DPI capabilities (e.g., including to identify a UE IP, IMSI, IMEI, APN, RAT Type, and/or User location information of, for example, Diameter messages over the SGi and/or other interfaces between P-GW 112 and Diameter Server 115 to apply context-based security traffic based on a policy (e.g., layer-7 security and/or other security policy enforcement)) as further described below.

As such, service providers and/or enterprises can use the disclosed techniques and security platform for applying intelligent security for zero trust in mobile networks with perimeter security platforms.

Various example use cases for applying intelligent security for zero trust in mobile networks with perimeter security platforms will now be described below.

Example Use Cases for Applying Intelligent Security for Zero Trust in Mobile Networks with Perimeter Security Platforms

The disclosed techniques for providing enhanced security for mobile/service provider networks using a security platform for security policy enforcement, including for applying context-based security using various protocols and interfaces (e.g., and a data store), can be applied in a variety of additional example use case scenarios for facilitating enhanced security for mobile networks (e.g., 4G/5G/6G and later mobile networks) as will now be described with respect to various example use cases.

As a first example use case, a security platform or similar device is configured to apply user and/or device identity-based security in an enterprise 5G network environment.

As a second example use case, a security platform or similar device is configured to apply advanced L7 security control for critical infrastructure devices connected to the 5G network environment.

As a third example use case, a mobile network service provider applies the disclosed techniques using a security platform to provide an advanced threat prevention service to manufacturing vertical enterprise 5G customers.

Example physical and logical implementations for an embodiment of a security platform will now be further described below.

Example Hardware Components of a Network Device for Applying Intelligent Security for Zero Trust in Mobile Networks with Perimeter Security Platforms

FIG. 4A is a functional diagram of hardware components of a network device for applying intelligent security for zero trust in mobile networks with perimeter security platforms in accordance with some embodiments. The example shown is a representation of physical/hardware components that can be included in network device 450 (e.g., an appliance, gateway, or server that can implement the Security Platform disclosed herein). Specifically, network device 450 includes a high performance multi-core CPU 452 and RAM 454. Network device 450 also includes a storage 460 (e.g., one or more hard disks or solid state storage units), which can be used to store policy and other configuration information as well as signatures. In one embodiment, storage 460 stores certain information (e.g., UE IP, IMSI, IMEI, APN, RAT Type, and/or user location information, and/or other protocol related/extracted message parameters, such as described herein with respect to various embodiments) that is extracted from monitored traffic over various interfaces (e.g., SGi, N4, N6, and/or other interfaces) that are monitored for implementing the disclosed security policy enforcement techniques for applying context-based security over various interfaces including the disclosed techniques for applying intelligent security for zero trust in mobile networks with perimeter security platforms as described herein. Network device 450 can also include one or more optional hardware accelerators. For example, network device 450 can include a cryptographic engine 456 configured to perform encryption and decryption operations, and one or more FPGAs 458 configured to perform signature matching, act as network processors, and/or perform other tasks.

Example Logical Components of a Network Device for Applying Intelligent Security for Zero Trust in Mobile Networks with Perimeter Security Platforms

FIG. 4B is a functional diagram of logical components of a network device for applying intelligent security for zero trust in mobile networks with perimeter security platforms in accordance with some embodiments. The example shown is a representation of logical components that can be included in network device 400 (e.g., a data appliance, which can implement the disclosed Security Platform and perform the disclosed techniques for applying intelligent security for zero trust in mobile networks with perimeter security platforms, and/or other context-based security over various interfaces in mobile networks). As shown, network device 400 includes a management plane 402 and a data plane 404. In one embodiment, the management plane is responsible for managing user interactions, such as by providing a user interface for configuring policies and viewing log data. The data plane is responsible for managing data, such as by performing packet processing and session handling.

Suppose a mobile device attempts to access a resource (e.g., a remote web site/server, a MEC service, an IoT device, or another resource) using an encrypted session protocol, such as SSL. Network processor 406 is configured to monitor packets from the mobile device and provide the packets to data plane 404 for processing. Flow 408 identifies the packets as being part of a new session and creates a new session flow. Subsequent packets will be identified as belonging to the session based on a flow lookup. If applicable, SSL decryption is applied by SSL decryption engine 410 using various techniques as described herein. Otherwise, processing by SSL decryption engine 410 is omitted. Application identification (APP ID) module 412 is configured to determine what type of traffic the session involves (e.g., PFCP, Radius, and/or Diameter traffic and/or other network protocols of traffic between various monitored interfaces, such as SGi, N4, N6, and/or other interfaces, as similarly described above with respect to FIGS. 1A-3F) and to identify a context associated with the traffic flow (e.g., to identify UE IP, IMSI, IMEI, APN, RAT Type, and/or user location information, and/or other protocol related/extracted message parameters as described herein). For example, APP ID 412 can recognize a GET request in the received data and conclude that the session requires a PFCP, Diameter, or Radius decoder 414. For each type of protocol, there exists a corresponding decoder 414. In one embodiment, the application identification is performed by an application identification module (e.g., APP ID component/engine), and a user identification is performed by another component/engine. Based on the determination made by APP ID 412, the packets are sent to an appropriate decoder 414. Decoder 414 is configured to assemble packets (e.g., which may be received out of order) into the correct order, perform tokenization, and extract out information (e.g., such to extract various information exchanged in PFCP, Radius, and/or Diameter traffic over various interfaces as similarly described above and further described below). Decoder 414 also performs signature matching to determine what should happen to the packet. SSL encryption engine 416 performs SSL encryption using various techniques as described herein and the packets are then forwarded using a forward component 418 as shown. As also shown, policies 420 are received and stored in the management plane 402. In one embodiment, policy enforcement (e.g., policies can include one or more rules, which can be specified using domain and/or host/server names, and rules can apply one or more signatures or other matching criteria or heuristics, such as for security policy enforcement for subscriber/IP flows on service provider networks based on various extracted parameters/information from monitored PFCP, Radius, and/or Diameter traffic and/or DPI of monitored PFCP, Radius, and/or Diameter and/or other protocol(s) traffic, such as SGi/N4/N6/other interfaces as similarly described above with respect to FIGS. 1A-3F) is applied as described herein with respect to various embodiments based on the monitored, decrypted, identified, and decoded session traffic flows.

As also shown in FIG. 4, an interface (I/F) communicator 422 is also provided for a Security Platform manager/management communications. In some cases, network communications of other network elements on the service provider network are monitored using network device 400, and data plane 404 supports decoding of such communications (e.g., network device 400, including I/F communicator 422 and decoder 414, can be configured to monitor and/or communicate on, for example, reference point interfaces such as SGi, N4, N6, and/or other interfaces where wired and wireless network traffic flow exists). As such, network device 400 including I/F communicator 422 can be used to implement the disclosed techniques for applying intelligent security for zero trust in mobile networks with perimeter security platforms in mobile networks as described above and as will be further described below.

Additional example processes for the disclosed techniques for applying intelligent security for zero trust in mobile networks with perimeter security platforms will now be described.

Example Processes for Applying Intelligent Security for Zero Trust in Mobile Networks with Perimeter Security Platforms

FIG. 5 is a flow diagram of a process for applying intelligent security for zero trust in mobile networks with perimeter security platforms using the PFCP protocol in accordance with some embodiments. In some embodiments, a process 500 as shown in FIG. 5 is performed by the Security Platform and techniques as similarly described above including the embodiments described above with respect to FIGS. 1A-IC. In one embodiment, process 500 is performed by data appliance 450 as described above with respect to FIG. 4A, network device 400 as described above with respect to FIG. 4B, a virtual appliance (e.g., Palo Alto Networks' VM Series virtualized next generation firewalls, CN Series container next generation firewalls, and/or other commercially available virtual-based or container-based firewalls can similarly be implemented and configured to perform the disclosed techniques), an SDN security solution, a cloud security service, and/or combinations or hybrid implementations of the aforementioned as described herein.

At 502, monitoring network traffic on a mobile network at a Security Platform to identify a new session is performed. For example, the Security Platform (e.g., a firewall, a network sensor acting on behalf of the firewall, or another device/component that can implement security policies) is deployed on the perimeter of a mobile network (e.g., 4G and/or 5G or later mobile network) and can monitor, in some cases, various protocols, such as the PFCP protocol (e.g., over SGi, Sxb, N4, N6, and/or other interfaces) and/or other protocols, on the mobile network, such as similarly described above with respect to FIGS. 1A-IC.

At 504, determining meta information associated with the new session by extracting the meta information from the PFCP traffic at the Security Platform via one or more interfaces is performed. For example, the security platform can be configured to process PFCP messages including PFCP session establishment request/response messages and/or PFCP session modification request/response messages to extract contextual information, which can include User Equipment (UE) IP, International Mobile Subscription Identity (IMSI)/Subscription Permanent Identifier (SUPI), IMEI/PEI, S-NSSAI, APN/DNN, and/or RAT Type information. as similarly described above with respect to FIGS. 1A-1C.

At 506, enforcing a security policy on the new session at the Security Platform based on the meta information to apply context-based security in the mobile network is performed. For example, security policy enforcement can include allowing or blocking the session or performing another action based on a policy, such as similarly described above.

FIG. 6 is another flow diagram of a process for applying intelligent security for zero trust in mobile networks with perimeter security platforms using the Radius protocol in accordance with some embodiments. In some embodiments, a process 600 as shown in FIG. 6 is performed by the Security Platform and techniques as similarly described above including the embodiments described above with respect to FIGS. 2A-2G. In one embodiment, process 600 is performed by data appliance 450 as described above with respect to FIG. 4A, network device 400 as described above with respect to FIG. 4B, a virtual appliance (e.g., Palo Alto Networks' VM Series virtualized next generation firewalls, CN Series container next generation firewalls, and/or other commercially available virtual-based or container-based firewalls can similarly be implemented and configured to perform the disclosed techniques), an SDN security solution, a cloud security service, and/or combinations or hybrid implementations of the aforementioned as described herein.

At 602, monitoring network traffic on a mobile network at a Security Platform to identify a new session is performed. For example, the Security Platform (e.g., a firewall, a network sensor acting on behalf of the firewall, or another device/component that can implement security policies) is deployed on the perimeter of a mobile network (e.g., 4G and/or 5G or later mobile network) and can monitor, in some cases, various protocols, such as the Radius protocol (e.g., over SGi, N6, Gx, Gy, Sd, and/or other interfaces) and/or other protocols, on the mobile network, such as similarly described above with respect to FIGS. 2A-2G.

At 604, determining meta information associated with the new session by extracting the meta information from the Radius traffic at the Security Platform via one or more interfaces is performed. For example, the security platform can be configured to process Radius messages including Accounting-Request(START)/Accounting-Response(START) and Accounting-Request(interim-update)/Accounting-Response(interim-update) messages to extract contextual information, which can include UE IP, IMSI, IMEI, APN, RAT Type, and/or user location information (e.g., examples of Attribute Value Pairs (AVPs) required in Radius messages include the following: Framed-IP-Address—IPv4 address of UE; Framed-IPv6-Prefix—IPv6 Prefix assigned to UE; and called-station-id—APN), as similarly described above with respect to FIGS. 2A-2G.

At 606, enforcing a security policy on the new session at the Security Platform based on the meta information to apply context-based security in the mobile network is performed. For example, security policy enforcement can include allowing or blocking the session or performing another action based on a policy, such as similarly described above.

FIG. 7 is another flow diagram of a process for applying intelligent security for zero trust in mobile networks with perimeter security platforms using the Diameter protocol in accordance with some embodiments. In some embodiments, a process 700 as shown in FIG. 7 is performed by the Security Platform and techniques as similarly described above including the embodiments described above with respect to FIGS. 3A-3F. In one embodiment, process 700 is performed by data appliance 450 as described above with respect to FIG. 4A, network device 400 as described above with respect to FIG. 4B, a virtual appliance (e.g., Palo Alto Networks' VM Series virtualized next generation firewalls, CN Series container next generation firewalls, and/or other commercially available virtual-based or container-based firewalls can similarly be implemented and configured to perform the disclosed techniques), an SDN security solution, a cloud security service, and/or combinations or hybrid implementations of the aforementioned as described herein.

At 702, monitoring network traffic on a mobile network at a Security Platform to identify a new session is performed. For example, the Security Platform (e.g., a firewall, a network sensor acting on behalf of the firewall, or another device/component that can implement security policies) is deployed on the perimeter of a mobile network (e.g., 4G and/or 5G or later mobile network) and can monitor, in some cases, various protocols, such as the Diameter protocol (e.g., over SGi, N6, Gx, Gy, Sd, and/or other interfaces) and/or other protocols, on the mobile network, such as similarly described above with respect to FIGS. 3A-3F.

At 704, determining meta information associated with the new session by extracting the meta information from the Diameter traffic at the Security Platform via one or more interfaces is performed. For example, the security platform can be configured to process Diameter messages including Accounting-Request(START)/Accounting-Response(START) and Accounting Request (Interim)/Accounting Answer (Interim) messages to extract contextual information, which can include UE IP, IMSI, IMEI, APN, RAT Type, and/or user location information (e.g., examples of Attribute Value Pairs (AVPs) required in Diameter messages include the following: Framed-IP-Address—IPv4 address of UE; Framed-IPv6-Prefix—IPv6 Prefix assigned to UE; and called-station-id—APN), as similarly described above with respect to FIGS. 3A-3F.

At 706, enforcing a security policy on the new session at the Security Platform based on the meta information to apply context-based security in the mobile network is performed. For example, security policy enforcement can include allowing or blocking the session or performing another action based on a policy, such as similarly described above.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A system, comprising:
a processor configured to:
monitor network traffic on a mobile network at a Security Platform to identify a new session, wherein the Security Platform is located at a perimeter of the mobile network;
determine meta information associated with the new session by extracting the meta information from the network traffic via one or more interfaces, wherein the network traffic includes a Packet Forwarding Control Protocol (PFCP); and
enforce a security policy on the new session at the Security Platform based on the meta information to apply context-based security in the mobile network; and
a memory coupled to the processor and configured to provide the processor with instructions.

2. The system recited in claim 1, wherein the Security Platform is configured to process PFCP messages to extract the meta information from the network traffic via the one or more interfaces.

3. The system recited in claim 1, wherein the Security Platform is located at the one or more interfaces at the perimeter of the mobile network.

4. The system recited in claim 1, wherein the Security Platform is located at the one or more interfaces at the perimeter of the mobile network selected from one or more of the following interfaces: SGi, Sxb, N4, and N6.

5. The system recited in claim 1, wherein the meta information includes User Equipment (UE) IP information.

6. The system recited in claim 1, wherein the meta information includes international Mobile Subscription Identity (IMSI) information.

7. The system recited in claim 1, wherein the meta information includes Subscription Permanent Identifier (SUPI) information.

8. The system recited in claim 1, wherein the meta information includes IMEI/PEI, information.

9. The system recited in claim 1, wherein the meta information includes S-NSSAI information.

10. The system recited in claim 1, wherein the meta information includes AMPN DNN information.

11. The system recited in claim 1, wherein the meta information includes RAT Type information.

12. The system recited in claim 1, wherein the meta information includes user location information.

13. The system recited in claim 1, wherein the meta information includes User Equipment (UE) IP, International Mobile Subscription Identity (IMSI)/Subscription Permanent Identifier (SUPI), IMEI/PEI, S-NSSAI, APN/DNN, and/or RAT Type information.

14. The system recited in claim 1, wherein the Security Platform is configured with a plurality of security policies to apply vulnerability protection, intrusion prevention, antivirus, antispyware, DNS security, denial of service (DoS) protection, and/or cloud-based security.

15. The system recited in claim 1, wherein the processor is further configured to:
block the new session from accessing a resource based on the security policy.

16. A method, comprising:
monitoring network traffic on a mobile network at a Security Platform to identify a new session, wherein the Security Platform is located at a perimeter of the mobile network;
determining meta information associated with the new session by extracting the meta information from the network traffic via one or more interfaces, wherein the network traffic includes a Packet Forwarding Control Protocol (PFCP); and
enforcing a security policy on the new session at the Security Platform based on the meta information to apply context-based security in the mobile network.

17. The method of claim 16, wherein the Security Platform is configured to process PFCP messages to extract the meta information from the network traffic via the one or more interfaces.

18. The method of claim 16, wherein the Security Platform is located at the one or more interfaces at the perimeter of the mobile network.

19. A computer program product, the computer program product being embodied in a non-transitory computer readable storage medium and comprising computer instructions for:
monitoring network traffic on a mobile network at a Security Platform to identify a new session, wherein the Security Platform is located at a perimeter of the mobile network;
determining meta information associated with the new session by extracting the meta information from the network traffic via one or more interfaces, wherein the network traffic includes a Packet Forwarding Control Protocol (PFCP); and
enforcing a security policy on the new session at the Security Platform based on the meta information to apply context-based security in the mobile network.

20. The computer program product recited in claim 19, wherein the Security Platform is configured to process PFCP messages to extract the meta information from the network traffic via the one or more interfaces.
